(19) United States
(12) Patent Application Publication
(10) Pub. No.: US 2026/0120236 A1
(43) Pub. Date: Apr. 30, 2026

(54) EFFICIENT NEURAL FRAME RATE UPSAMPLING PIPELINE

(71) Applicant: Arm Limited, Cambridge (GB)

(72) Inventors: Joshua James Sowerby, London (GB); Liam James O’Neil, Stretford (GB); Yanxiang Wang, Sale (GB); Matthew James Wash, Pampisford (GB)

(21) Appl. No.: 18/933,867

(22) Filed: Oct. 31, 2024

(51) Int. Cl. G06T 3/4046; G06T 3/18; G06T 3/4007

(52) U.S. Cl. CPC G06T 3/4046; G06T 3/18; G06T 3/4007

(57) ABSTRACT

An interpolated output frame may be generated by generating a preceding warped motion vector frame from a preceding image frame and a following warped motion vector frame from a following image frame using motion vectors. A preceding warped optical flow frame is also generated from a preceding image frame and a following warped optical flow frame is generated from a following image frame using optical flow. Blending parameters are predicted, associated with each of the motion vector frames and the optical flow frames for blending the motion vector frames and the optical flow frames to generate an interpolated output frame. Either the motion vector frames or the optical flow frames are blended using the predicted blending parameters for each pixel in the interpolated output frame, based on whether a highest blending parameter for the pixel is associated with a motion vector frame or an optical flow frame.

### FIELD

The field relates generally to processing a rendered image, and more specifically to an efficient neural frame rate upsampling pipeline.

### BACKGROUND

Rendering images using a computer has evolved from low-resolution, simple line drawings with limited colors made familiar by arcade games decades ago to complex, photo-realistic images that are rendered to provide content such as immersive game play, virtual reality, and high-definition CGI (Computer-Generated Imagery) movies. While some image rendering applications such as rendering a computer-generated movie can be completed over the course of many days, other applications such as video games and virtual reality or augmented reality may entail real-time rendering of relevant image content. Because computational complexity may increase with the degree of realism desired, efficient rendering of real-time content while providing acceptable image quality is an ongoing technical challenge.

Producing realistic computer-generated images typically involves a variety of image rendering techniques, from rendering perspective of the viewer correctly, rendering different surface textures, and providing realistic lighting. But rendering an accurate image takes significant computing resources, and becomes more difficult when the rendering must be completed many tens to hundreds of times per second to produce desired framerates for game play, augmented reality, or other applications. Specialized graphics rending pipelines can help manage the computational workload, providing a balance between image quality and rendered images or frames per second using techniques such as taking advantage of the history of a rendered image to improve texture rendering. Rendered objects that are small or distant may be rendered using fewer triangles than objects that are close, and other compromises between rendering speed and quality can be employed to provide the desired balance between frame rate and image quality.

In some embodiments, an entire image may be rendered at a lower resolution than the eventual display resolution, significantly reducing the computational burden in rendering the image. In other examples, the number of frames rendered may be less than the number of frames presented for display, such as rendering at 60 frames per second while displaying images on a display with a refresh rate of 120 frames per second. As developers often choose to use advances in rendering and graphics processing unit (GPU) technology to produce higher-resolution images with enhancements such as ray tracing to improve the fidelity or visual quality of rendered images, frame rates of mobile games and other applications often do not keep pace with advances in display technology.

Some rendering systems therefore attempt to increase the perceived frame rate of rendered image sequences such as by interpolating between rendered image frames. But, generating an additional frame that exists between two previously-rendered frames in time is not an easy task, should desirably be performed with significantly less computational burden than actually rendering the additional frame for the interpolation process to be useful. Further, solutions that may work on desktop computers or video game consoles having high bandwidth and high power budgets may not be well-suited to portable or mobile devices such as smartphones or tablet computers.

For reasons such as these, it is desirable to perform frame interpolation for rendered image streams in a way that is computationally efficient and power efficient.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 shows an image frame diagram illustrating interpolation between consecutive rendered image frames, consistent with an example embodiment.

FIG. 2 shows a block diagram of a rendered image stream frame interpolation process, consistent with an example embodiment.

FIG. 3 shows a block diagram of a rendered image stream frame interpolation inference process, consistent with an example embodiment.

FIG. 4 is a flow diagram of a method of using a neural network to generate a blended interpolated image frame, consistent with an example embodiment.

FIG. 5 is a flow diagram of a method of generating an interpolated image frame using reduced-resolution processing, consistent with an example embodiment.

FIG. 6 is a schematic diagram of a neural network, consistent with an example embodiment.

FIG. 7 shows a computing environment in which one or more image processing and/or filtering architectures (e.g., image processing stages, FIG. 1) may be employed, consistent with an example embodiment.

FIG. 8 shows a block diagram of a general-purpose computerized system, consistent with an example embodiment.

Reference is made in the following detailed description to accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As graphics processing power available to smart phones, personal computers, and other such devices continues to grow, computer-rendered images continue to become increasingly realistic in appearance. These advances have enabled real-time rendering of complex images in sequential image streams, such as may be seen in games, augmented reality, and other such applications, but typically still involve significant constraints or limitations based on the graphics processing power available. For example, images may be rendered at a lower resolution than the eventual desired display resolution, with the render resolution based on the desired image or frame rate, the processing power available, the level of image quality acceptable for the application, and other such factors. Many developers elect to use available graphics resources to render with a high fidelity visual quality or resolution, compromising in other areas such as frame rate (or the number of frames rendered per unit of time). Many computer graphics applications such as advanced games therefore look substantially better than a decade ago, but do not make use of recent advances in display refresh rates.

Some approaches to addressing problems such as these may involve interpolating between rendered frames using an algorithm that is more computationally efficient than rendering the interpolated frame. Interpolation between rendered frames may be somewhat complex in that rendered objects may be moving not only side to side or up and down, but may also be moving toward or away from the viewer's vantage point (e.g., a rendered object may be changing in apparent size), may be accelerating, or may have shadows or other lighting effects not captured by motion vectors associated with the rendered objects. For reasons such as these, rendered frame interpolation algorithms have largely focused on desktop computer-grade high-performance and high-power discrete GPU devices, and are not low-power or mobile device-friendly.

Some examples presented herein therefore employ using various methods that are mobile device-friendly and consume less power and fewer computing resources, such as reduced-resolution motion vector scattering in generating an interpolated frame and using alpha blending coefficients generated via a neural network to select or blend between different warped interpolated frames on a per-pixel level.

In one such example, an interpolated output frame may be generated by generating motion vector frames, comprising generating a preceding warped motion vector frame from a preceding image frame using motion vectors and generating a following warped motion vector frame from a following image frame using motion vectors. Optical flow frames are also generated, comprising generating a preceding warped optical flow frame from a preceding image frame using optical flow and generating a following warped optical flow frame from a following image frame using optical flow. Blending parameters are predicted, associated with each of the motion vector frames and the optical flow frames for blending the motion vector frames and the optical flow frames to generate an interpolated output frame. Either the motion vector frames or the optical flow frames are blended using the predicted blending parameters for each pixel in the interpolated output frame, based on whether a highest blending parameter for the pixel is associated with a motion vector frame or an optical flow frame.

In another example, a computing device, comprises a memory comprising one more storage devices and one or more processors coupled to the memory, the one or more processors operable to execute instructions stored in the memory. The one more instructions are operable, when executed, to generate motion vector frames, comprising generating a preceding warped motion vector frame from a preceding image frame using motion vectors, and generate a following warped motion vector frame from a following image frame using motion vectors. The instructions are further operable when executed to generate optical flow frames, comprising generating a preceding warped optical flow frame from a preceding image frame using optical flow, and generating a following warped optical flow frame from a following image frame using optical flow. The executed instructions are further operable to predict blending parameters associated with each of the motion vector frames and the optical flow frames for blending the motion vector frames and the optical flow frames to generate an interpolated output frame, and for each pixel in the interpolated output frame, to blend either the motion vector frames or the optical flow frames using the predicted blending parameters based on whether a highest blending parameter for the pixel is associated with a motion vector frame or an optical flow frame.

In some such examples, a trained neural network is employed to predict blending parameters. The neural network may be trained in some examples by receiving an input tensor in an input layer of the neural network, the input tensor representing a preceding motion vector frame, a following motion vector frame, a preceding optical flow frame, and a following optical flow. An output tensor may be provided to an output layer of the neural network, the output tensor representing one or more coefficients predicting blending parameters to be used in blending either the preceding and following motion vector frames or the preceding and following optical flow frames based on whether a highest blending parameter for the pixel is associated with a motion vector frame or an optical flow frame. The neural network may be trained to predict the provided output tensor based on the received input tensor by using backpropagation to adjust a weight of one or more activation functions linking one or more nodes of one or more layers of the neural network.

Examples such as these can use blending parameters predicted by a trained neural network to effectively determine whether motion vector or optical flow-based interpolated image frames are likely to produce the best image result in generating an interpolated image frame, such that the blending parameters for either the preceding and following motion vector frames or for the preceding and following optical flow frames can be used in a blending process to produce an interpolated image frame. In some examples, use of reduced resolution for some steps, such as for neural network processing, generating interpolated motion vector or optical flow-based image frames used as inputs to the neural network, and other processing of such image frames may help reduce the computational burden of generating interpolated image frames and reduce power consumption while having minimal visible effect on the fidelity or quality of the output interpolated image frame.

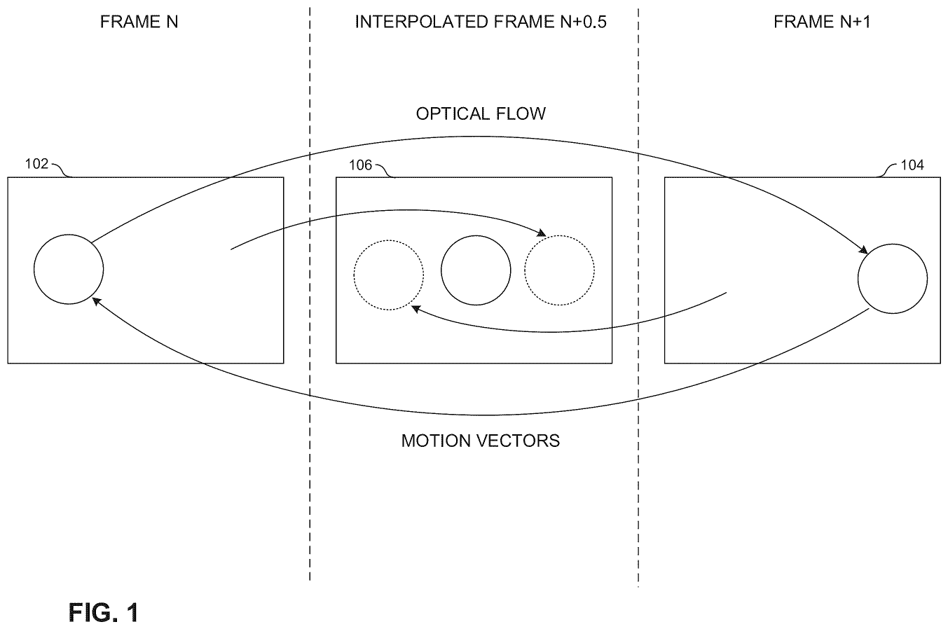

FIG. 1 shows an image frame diagram illustrating interpolation between consecutive rendered image frames, consistent with an example embodiment. Here, consecutive image frames N and N+1 are shown at 102 and 104, respectively. To increase the apparent frame rate of the rendered image stream, an interpolated image frame N+0.5 is generated as shown at 106. In this example, a single interpolated image frame is shown at a time centered between image frame N and image frame N+1, while other embodiments may include multiple interpolated image frames between rendered image frames, interpolated image frames spaced at intervals other than a whole-number multiple of the original image frame rate, or the like.

The interpolated image frame shown at 106 in this example reflects that the position of a round object, such as a ball, has moved to the right approximately half the distance of its movement between sequentially rendered image frames 102 and 104. In further examples, the movement of at least some objects between rendered image frames may further account for acceleration, such that the object may be placed somewhere other than the midpoint between its position in the frames preceding and following the interpolated frame.

The example interpolated frame 106 further illustrates how certain areas of the frame are disoccluded or no longer covered by the rendered ball object, resulting in the background or other rendered objects having greater depth becoming visible between frames due to the ball's movement. This is reflected by the balls in interpolated frame 106 shown using dashed lines, with arrows reflecting that these disoccluded areas may be selectively copied from the same areas of frames 102 and 104.

If the perspective of the camera changes between image frames or objects otherwise move between sequential image frames, the image frames may be warped in generating effects such as interpolation, disocclusion, and the like. In a simplified example, if the camera is panning to the right between frames 102 and 104 of the example of FIG. 1, this panning will desirably be accounted for in copying disoccluded elements of the background, illumination, or other objects into interpolated frame 106.

Motion vectors associated with objects such as the rendered ball of FIG. 1 may be used to help form an interpolated image of the ball or other objects such as in interpolated image frame 106, but may not account for differences in illumination, shadows, and other such features. Features such as these may be tracked separately from motion vectors in some examples using optical flow, which may track the movement of various features of an image across sequential image frames without prior knowledge of the objects rendered in the frames. While optical flow may be similar in some ways to motion vectors in that it tracks movement in image sequences, it may be less precise than tracking rendered objects. Although optical flow may be somewhat less accurate, it may produce visibly better tracking of things like lighting and shadows that are not rendered objects having associated motion vectors.

Motion vectors in the example of FIG. 1 are calculated from the perspective of the most recently-rendered frame, shown at 104, looking back to the preceding rendered frame 102, as shown by the motion vectors line and arrow near the bottom of FIG. 1. The rendering engine has knowledge of both the current frame (e.g. frame 104) and the prior rendered frame, and so can calculate the most up-to-date motion vectors looking back from the previous frame. Optical flow, in this example, may be calculated looking forward from a past frame to the current frame as represented by the optical flow line and arrow near the top of FIG. 1.

Motion vectors may be scattered or pushed into the interpolated frame of reference by multiplying motion vectors from image frame 104 on a per-pixel basis by 0.5, but this may result in write collisions such as where a rendered object is moving nearer or farther the viewer or camera's perspective between frames. In one such example, multiple pixels of a ball that is closer in rendered image frame 104 than in interpolated image frame 106 may map to the same pixel in interpolated image frame 106, causing write collisions and leaving some pixel locations unwritten. Similar problems may exist with optical flow, with scatter or push operations potentially including data collisions in some pixels and leaving some pixels unwritten.

Problems such as these may be addressed by using a depth buffer and pushing depth information along with motion vector or optical flow information into the interpolated frame of reference 106. If each scatter or push operation includes associated pixel depth information, methods such as retaining only the motion vector or optical flow vector associated with the nearest depth can ensure that only the most relevant motion vector or optical flow information is kept per pixel. Holes or unwritten pixels may further be filled using various techniques such as averaging, selecting a nearest neighbor, or other such methods. In one such example, the motion vector or optical flow vector having the nearest depth that is not a hole is selected from a 3×3 mask around the pixel having a hole.

Once the nearest depth is known via a scattering pass, the depth information can be used to warp preceding and following frames into the interpolated frame position if the depth value associated with the pixel matches the known nearest depth associated with the pixel. The depth of the nearest object per pixel for preceding and following frames may further be used to identify disocclusions, such as where the depth difference exceeds a threshold value, and may be used to flag such pixels to a neural network as possibly disoccluded (or occluded) pixels. In a further example, methods described herein may be acceleration-aware, such as where warping, depth, disocclusion, or other such calculations are computed using knowledge of acceleration of a rendered object rather than simply using linear interpolation.

Color information, such as RGB values for pixels, could similarly be scattered or pushed into the interpolated frame using a scatter operation, but this again is computationally somewhat expensive as it cannot be parallelized and involves random access reads to preceding and/or subsequent image frames. Some examples therefore may scatter or push motion vectors and/or optical flow vectors into the interpolated frame 106's frame of reference, along with depth information from preceding and following rendered image frames. Although reducing the resolution of color data copied to the interpolated frame 106 may show subsampling-like artifacts, the resolution of the scattered motion vectors and/or optical flow vectors may be reduced relative to the resolution of the preceding and following rendered image frames without creating such visible artifacts and speed up the relatively time-consuming scatter operation and increasing computational efficiency of subsequent warping operations.

The reduced resolution motion vectors and optical flow may be used to gather color frame information into the interpolated frame 106 by extrapolating or expanding the resolution of the motion and/or optical flow vectors, such as by using bilinear interpolation, and iterating over the interpolated space rather than the preceding and/or following rendered image frame space. Gathering color information using depth information and motion vectors and/or optical flow vectors enables gathering color information into the interpolated image space 106 rather than scattering information from the preceding and/or following rendered images, avoiding write collisions and holes in the gathered color information.

In a more detailed example, the motion vector and optical flow vector information can be scaled to gather color information from the preceding and following frames, generating preceding and following gathered warped motion vector frames and preceding and following gathered warped optical flow frames. These four frames may be used as input to a neural network to generate blending coefficients or alpha for blending between these four frames, such that the blending coefficients may be subsequently applied to at least some of these four frames in a blending operation to generate an output interpolated image frame. In a further example, the four frames may be generated at a reduced resolution (such as ¼ or 1/16 the original rendered image frame resolution), such as to reduce the computational burden in the scatter/gather operation, warping the image frames to an intermediate time position, and the like.

The neural network in various examples may be trained using sequentially rendered frames, such as using time T=0 and T=2 rendered image frames to generate inputs and T=1 rendered frames to generate blending values as predicted outputs. The neural network may thereby learn to identify image features such as shadows that are better represented by optical flow than by motion vectors, learn to spot disocclusions, and other such image characteristics as may be useful in generating the predicted output. Although the neural network in this example may perform blending value compositing using color domain information, other examples may use motion vector and optical flow loss as well or in place of such color domain information. In one such example, motion vector and optical flow vector information may point in different directions, so can train network to make a binary choice between motion vector and optical flow frames. Because the blending coefficients are not based on color space and color information is derived directly from preceding and following rendered image frames, methods such as those described herein may work on High Dynamic Range (HDR) video or video using other color spaces or encodings

In a further example, the blending for each pixel may occur either between the preceding and following motion vector frames or between the preceding and following optical flow frames based on whether a motion vector frame or an optical flow frame has the highest blending parameter value for that pixel. This avoids having to blend four different image values for each pixel, reducing both the computational cost of the blending operation which may take place at the full resolution of the preceding and following image frames. In some further examples, other computationally expensive operations such as warping preceding and following image frames using both optical flow and motion vectors at full resolution can be avoided, as the blending parameter having the highest value from among the four preceding and following motion vector and optical flow blending parameters allows warping and blending only the preceding and following motion vector frames or warping and blending only the preceding and following optical flow frames.

These examples show how use of motion vectors and optical flow at reduced resolution can decrease the computational burden on interpolating between rendered image frames without significantly impacting interpolated image quality, and how a neural network can be used to predict blending values between motion vector-derived interpolated image pixels and optical flow-derived image pixels within a single interpolated image frame. Using methods such as these may significantly improve performance of rendered image interpolation in devices with limited compute resources or a limited power budget, such as mobile devices like smartphones or tablet computers.

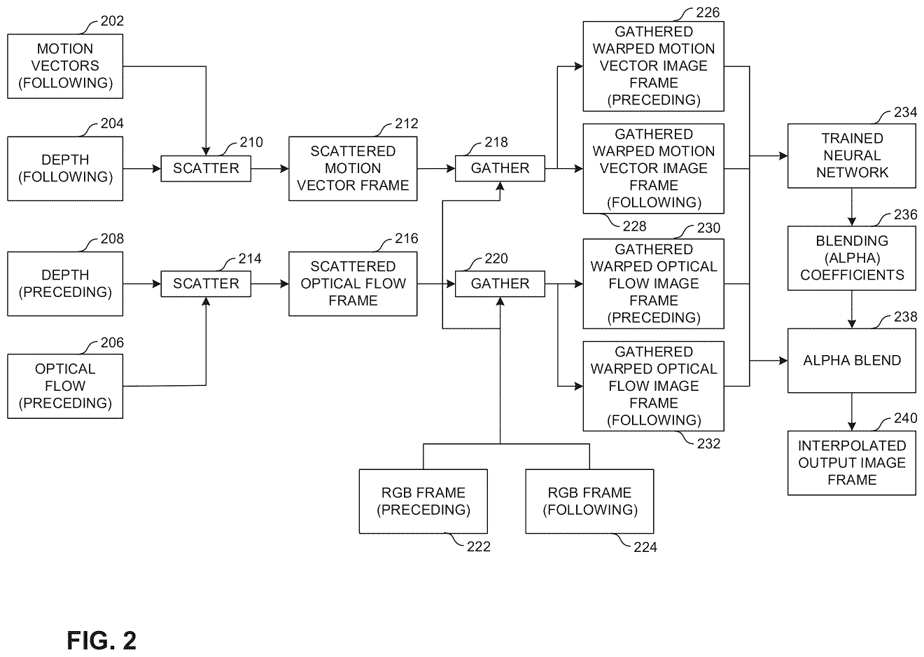

FIG. 2 shows a block diagram of a rendered image stream frame interpolation process, consistent with an example embodiment. Here, motion vector frame 202 and depth frame 204 are derived from a rendered image frame immediately following the interpolated frame being generated in a rendered image sequence, and optical flow frame 206 and depth frame 208 are derived from a rendered image frame immediately preceding the interpolated frame being generated. The motion vectors 202 and associated motion vector depth information are scattered at 210 into a motion vector frame 212 that is time-aligned with the interpolated image frame being generated. The optical flow 206 from the preceding image frame and associated depth information 208 are similarly scattered at 214 into a scattered optical flow frame 216 that is also time-aligned with the interpolated image frame being generated. These scattered motion vector frames 212 and scattered optical flow frames 216 may in some examples employ methods such as those described in FIG. 1 to avoid write collisions and holes in scattered data, such as selecting the nearest depth scatter candidate for each pixel and filling any holes or unfilled pixels with a neighboring pixel value having the nearest depth that is not also a hole.

The scattered motion vector frame 212 may then be used in a gather operation to gather color information from preceding or following RGB frames 222 and 224, thereby generating a pair of gathered and warped motion vector RGB frames-one based on the preceding RGB frame as shown at 226 and one based on the following RGB frame as shown at 228. Gather operation 220 is similarly performed based on the scattered optical flow frame 216, generating gathered warped optical flow frame 230 based on color information from the preceding RGB frame 222 and gathered warped optical flow frame 230 based on the following RGB frame 224.

These four RGB frames each contain different estimates of the color information for the interpolated output image frame, based on either the preceding or following RGB frame's color information and on either motion vectors or optical flow. Selecting from among these four RGB frames 226-232 for inclusion in the interpolated output image frame is performed here by providing the four image frames, image frame depth information, and other such information to a trained neural network 234. The trained neural network in various examples may be trained using rendered data to recognize disocclusions, to differentiate between moving rendered objects and light or other optical flow phenomena, and to recognize other information relevant in choosing between the four RGB frame candidates 226-232.

The neural network 234 provides as an output blending coefficients (or alpha coefficients) for each pixel location for each of the four RGB image frame candidates 226-232, such that the blending coefficients may be used in an alpha blend operation at 238 to blend the four RGB image frame candidates together in the indicated per-pixel proportions to generate an interpolated output frame 240.

In further examples, the resolution of one or more steps in the process shown here may occur at reduced resolution to reduce the computational burden and power consumed in various steps, such as reducing the resolution at which motion vectors and optical flow are scattered from the preceding and following RGB frames at 210-216, warping the depth of the motion vectors and optical flow, performing hole filling in scattered interpolated image frames, generating RGB candidate frames at 226-232 using gather operations 218-220, using the neural network 234 to generate blending coefficients 236, and the like. Interpolated output frame 240 may optionally be upscaled to the original resolution such as during postprocessing after the alpha blend step 238 to retain image fidelity of the interpolated frame, making the interpolated output frame appear substantially similar to a rendered and ray-traced output frame.

Because the example of FIG. 2 may use blending parameters to blend between the four candidate image frames 226-232, these image frames may desirably have a resolution high enough to generate an interpolated image frame with similar image fidelity to the preceding and following image frames. But, performing four gather and warp operations at the full resolution of the preceding and following image frames is computationally expensive, and so may impose a tradeoff between image quality and computational efficiency. Some example embodiments may therefore generate the four candidate frames 226-232 at reduced resolution, while using either full resolution preceding and following optical flow frames or full resolution preceding and following motion vector frames to generate the interpolated output image. By only blending between two full-resolution image frames based on whether the highest blending parameter is associated with an optical flow frame or a motion vector frame, gathering and warping four complete full-resolution frames need not be performed to generate a full-resolution interpolated output image having high image fidelity. In some such examples, the pipeline of FIG. 2 or a similar pipeline may still be employed, ensuring that the neural network is trained on all four blending parameters per pixel.

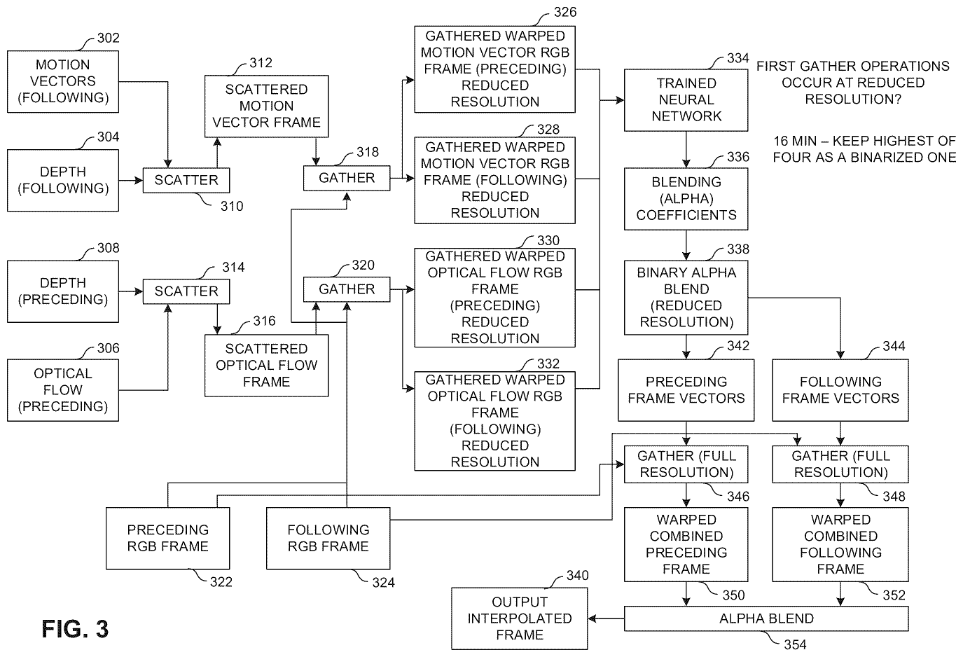

FIG. 3 shows a block diagram of a rendered image stream frame interpolation inference process, consistent with an example embodiment. FIG. 3 shows generally an image processing pipeline or process similar to that of FIG. 2, but that has improved efficiency when use to perform inference or to generate interpolated images using a trained neural network. More specifically, the four candidate frames 326-332 are here gathered and warped at a reduced resolution relative to the preceding RGB frame 322 and the following RGB frame 324, such as being ¼, 1/16, or another suitable fraction of the size of the preceding and following RGB frames. This reduced size reduces the computational burden in computing the four gathered and warped candidate frames provided as input to the trained neural network 334, while maintaining sufficient resolution to indicate what areas of an interpolated image are best represented by motion vectors or optical flow. The output of the trained neural network 334 in this example will be four blending parameters or coefficients, indicating the relative proportion of each of the four candidate frames to blend in generating an interpolated output frame.

The blending or alpha coefficients are likely to indicate one of the four frames to a significantly higher degree than the other three, such as by outputting a higher blending coefficient or parameter value. In some embodiments, the candidate frame having the highest blending parameter will be determined, along with a determination as to whether the candidate frame having the highest blending parameter value is a motion vector candidate frame (326-328) or an optical flow candidate frame (330-332). If the candidate frame having the highest blending parameter is a motion vector frame, only motion vector frames may be used in gathering and warping, and blending an output interpolated frame, and if the candidate frame having the highest blending parameter is an optical flow frame, only optical flow frames may be used in gathering, warping, and blending the output interpolated frame. In an alternate example, the blending parameters received at 336 from the trained neural network 334 for the two motion vector candidate frames (326-328) are added and the blending parameters for the two optical flow candidate frames (33-332) are added, and the candidate frame pair having the highest added or summed value are used in gathering, warping, and blending to generate the output interpolated frame 340.

In a more detailed example, the blending parameters or alpha coefficients 336 received as an output from the trained neural network 334 may be processed via binary alpha blend at 338 to determine whether the motion vector or optical flow candidate frame pairs have the higher blending coefficient. In a more detailed example, the four alpha coefficients from 336 may be reduced to two coefficients that describe whether to use motion vector or optical flow and whether to use the preceding or following frame, such as by using an argmax (or maximum value determination) function on the alpha parameters. A set of preceding frame vectors are obtained at 342 and a set of following frame vectors are obtained at 344, such as from the scattered motion vector frame 312 or the scattered optical flow frame 316, or may be separately derived from preceding and following frames such as using a scatter operation as described in FIG. 2. Both the preceding frame vectors 342 and following frame vectors 344 are either motion vector frame vectors or optical flow frame vectors based on the determination made at 338. The preceding and following frame vectors may be upsampled or calculated at the full preceding or following frame (322 or 324) resolution, or may be at a reduced resolution such as the resolution of the four candidate image frames 326-332 in various examples. The preceding and following frame vectors are used at 346 and 348 to perform gather operations on the preceding RGB frame and the following RGB frame respectively, much as was done at 318-332, but at full resolution. The gathered frames are warped using the preceding and following frame vectors from 342 and 344, generating warped combined preceding frame 350 and warped combined following frame 352. Each of the warped combined frames 350 and 352 are in this example at full image resolution (or the same resolution as preceding and following RGB frames 322 and 324), and are based on either motion vectors or optical flow depending on binarization of the blending coefficients output from the trained neural network as performed at 334-338.

The warped combined preceding frame 350 and warped combined following frame are blended at 354 based on their respective blending parameters or alpha coefficients, and are combined to form a full-resolution output interpolated image frame 340. Because either motion vectors or optical flow vectors are selected at 338 for the gathering, warping, and blending at full resolution, the non-selected vectors need not undergo the gather, warp, and blend process at full resolution, saving considerable computational resources.

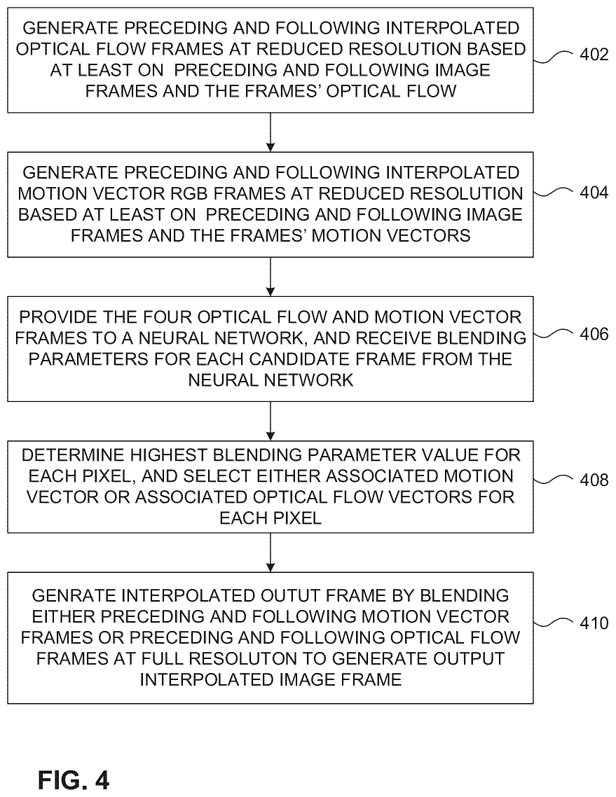

The trained neural network 334 in this example is trained using four candidate frames as inputs, including preceding and following motion vector frames and preceding and following optical flow frames, and outputs a blending coefficient for each of the four candidate frames for each pixel location. Because the final processing elements of FIG. 3 (338-354) are performed using only either motion vector frames and motion vectors or optical flow frames and optical flow vectors, training the neural network may be performed in a different pipeline or topology such as that of FIG. 2 that employs all four blending parameters and candidate image frames in generating the output interpolated frame. The neural network may thereby be trained to better discriminate between when to use optical flow and when to use motion vectors to generate the output interpolated frame, as error backpropagation for both may exist for each training sample. FIG. 4 is a flow diagram of a method of generating an interpolated output frame, consistent with an example embodiment. Here, four reduced resolution candidate frames are generated, including at 402 a preceding interpolated optical flow frame based on a preceding rendered image frame and a following interpolated optical flow frame based on a following rendered image frame. A preceding interpolated motion vector frame based on the preceding rendered image frame is further generated at 404, along with a following interpolated motion vector frame based on the following rendered image frame. These four candidate image frames may be at a reduced resolution chosen based on both reducing the computational resources used to perform scatter-gather operations, image frame warping, and/or other such processes employed to generate the candidate image frames, and on a desired degree of fidelity of an output interpolated image frame. In some such examples, the four candidate image frames may be a fraction of the horizontal and vertical resolution of the full resolution preceding and following rendered image frames, such as ½ the vertical and horizontal resolution of the full resolution image frames or ¼ the vertical and horizontal resolution of the full resolution image frames.

The four reduced resolution candidate image frames are provided to a neural network at 406, which has been trained to predict blending values indicating a proportion to which the four candidate image frames may be blended to generate an interpolated output frame. At 408, the candidate image frame having the highest predicted blending value is identified, along with whether the identified candidate image frame is an optical flow image frame or a motion vector image frame. At 410, the interpolated output image frame is generated by blending either motion vector image frames or the optical flow image frames at full resolution, based on which pair of image frames was identified as including the corresponding reduced resolution candidate frame having the highest predicted blending value at 408. This is performed in a more detailed example by blending the preceding warped motion vector frame and the following warped motion vector frame using the predicted blending parameters if a highest blending parameter for the pixel is a preceding warped motion vector frame parameter or a following warped motion vector frame parameter, or blending the preceding warped optical flow frame and the following warped optical flow frame using the predicted blending parameters if a highest blending parameter for the pixel is a preceding warped optical flow frame parameter or a following warped optical flow frame parameter. The blending process generates a full resolution interpolated output frame, which may be displayed between the preceding and following image frames to improve the apparent framerate of a rendered image stream such as a rendered video game, a virtual reality display, or the like.

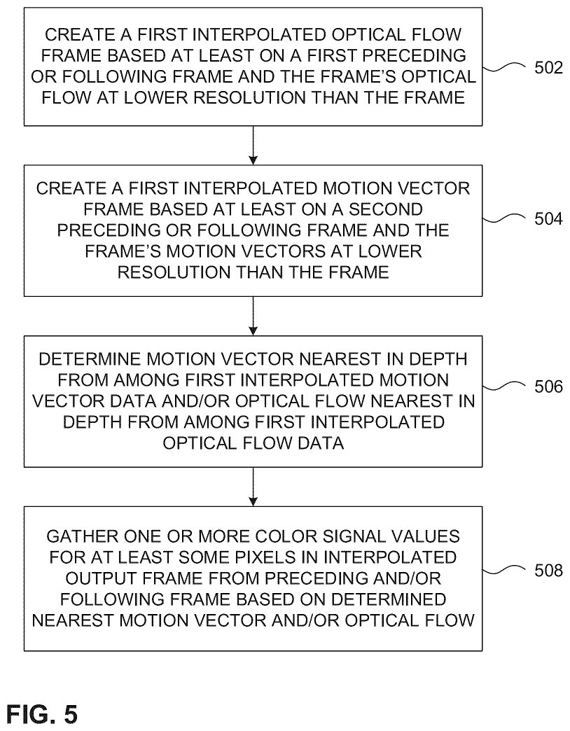

FIG. 5 is a flow diagram of a method of generating an interpolated image frame using reduced-resolution processing, consistent with an example embodiment. Here, a first interpolated optical flow frame is generated at 502, based at least on a first preceding or following frame and the frame's optical flow, at a resolution less than the first preceding or following frame. In a further example, interpolated optical flow frames may be generated based on each of the preceding and following image frames and their respective optical flow. At 404, a first interpolated motion vector frame is similarly generated based at least on a second preceding or following frame and that frame's motion vectors, also at a resolution less than the second preceding or following frame. In further examples, interpolated motion vector frames based on each of the preceding and following image frames and their respective motion vectors may be generated. The interpolated motion vector and optical flow frames may again be populated using a scatter-and-gather method as described in previous examples, may be warped, may be hole-filled, and/or may undergo other such processing.

At 506, the motion vector nearest in depth from among the first interpolated motion vector data may be determined as part of a scatter operation to resolve write collisions, such as using the methods described in the example of FIG. 1. The optical flow nearest in depth may similarly be determined from among the first interpolated optical flow data. One or more color signal values are gathered from at least some pixels in the interpolated frame from the preceding and/or following frames based on the determined nearest motion vector and/or optical flow at 508. In a more detailed example, color signal values for the first interpolated optical flow frame are gathered from at least the preceding image frame from which the first interpolated optical flow frame is derived, and color signal values for the first interpolated motion vector frame are gathered from at least the following image frame from which the first interpolated motion vector frame is derived.

In a further example, second interpolated optical flow frames and motion vector frames are also produced at a lower resolution than the rendered image frames and color signal values are gathered for such frames at 508, such as a second interpolated optical flow frame based at least on a following rendered image frame and a second interpolated motion vector frame based at least on a preceding rendered image frame. This process may therefore generate both interpolated motion vector and optical flow frames based on both the preceding and following rendered image frames, resulting in four interpolated image frames that may in some examples comprise frames at lower resolution than the preceding and following rendered image frames such as to provide reduced resolution input to a neural network. These four frames in a further example may be used (e.g., at full resolution as in the example of FIG. 2 or at reduced resolution as in the example of FIG. 3) as candidate frames for blending to create an interpolated output image, such as using blending coefficients generated by a neural network using input tensor data such as the four candidate interpolated image frames and their associated depth information.

Various parameters in the examples presented herein, such as blending coefficients and other such parameters, may be determined using machine learning techniques such as a trained neural network. In some examples, a neural network may comprise a graph comprising nodes to model neurons in a brain. In this context, a “neural network” means an architecture of a processing device defined and/or represented by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

In one example embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

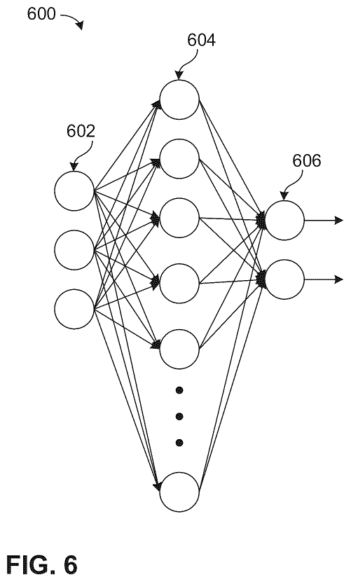

FIG. 6 is a schematic diagram of a neural network 600 formed in “layers” in which an initial layer is formed by nodes 602 and a final layer is formed by nodes 606. All or a portion of features of neural network 600 may be implemented various embodiments of systems described herein. Neural network 600 may include one or more intermediate layers, shown here by intermediate layer of nodes 604. Edges shown between nodes 602 and 604 illustrate signal flow from an initial layer to an intermediate layer. Likewise, edges shown between nodes 604 and 606 illustrate signal flow from an intermediate layer to a final layer. Although FIG. 6 shows each node in a layer connected with each node in a prior or subsequent layer to which the layer is connected, i.e., the nodes are fully connected, other neural networks will not be fully connected but will employ different node connection structures. While neural network 600 shows a single intermediate layer formed by nodes 604, other implementations of a neural network may include multiple intermediate layers formed between an initial layer and a final layer.

According to an embodiment, a node 602, 604 and/or 606 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect.

Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” as referred to herein means an expression of one or more activation input values according to a particular structure, dimension and/or format. Likewise in this context, an “activation output tensor” as referred to herein means an expression of one or more activation output values according to a particular structure, dimension and/or format.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques to iteratively update neural network weights to be associated with nodes and/or edges of a neural network based, at least in part on “training sets.” Such training sets may include training measurements and/or observations to be supplied as input values that are paired with “ground truth” observations or expected outputs. Based on a comparison of such ground truth observations and associated prediction values generated based on such input values in a training process, weights may be updated according to a loss function using backpropagation. The neural networks employed in various examples can be any known or future neural network architecture, including traditional feed-forward neural networks, convolutional neural networks, or other such networks.

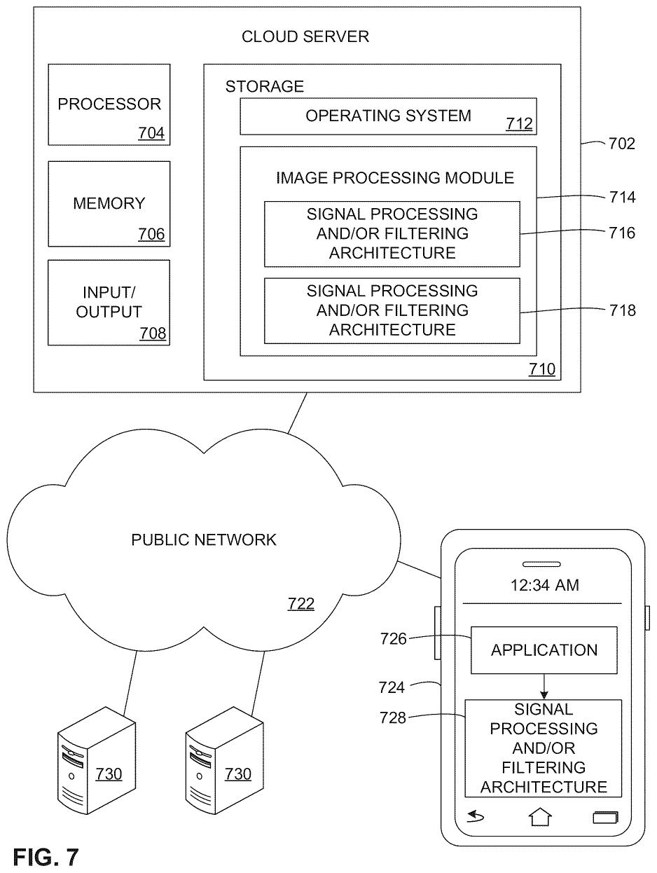

FIG. 7 shows a computing environment in which one or more image processing and/or filtering architectures (e.g., image processing stages, FIGS. 2 and 3A-3B) may be employed, consistent with an example embodiment. Here, a cloud server 702 includes a processor 704 operable to process stored computer instructions, a memory 706 operable to store computer instructions, values, symbols, parameters, etc., for processing on the cloud server, and input/output 708 such as network connections, wireless connections, and connections to accessories such as keyboards and the like. Storage 710 may be nonvolatile, and may store values, parameters, symbols, content, code, etc., such as code for an operating system 712 and code for software such as image processing module 714. Image processing module 714 may comprise multiple signal processing and/or filtering architectures 716 and 718, which may be operable to render and/or process images. Signal processing and/or filtering architectures may be available for processing images or other content stored on a server, or for providing remote service or “cloud” service to remote computers such as computers 730 connected via a public network 722 such as the Internet.

Smartphone 724 may also be coupled to a public network in the example of FIG. 7, and may include an application 726 that utilizes image processing and/or filtering architecture 728 for processing rendered images such as a video game, virtual reality application, or other application 726. Image processing and/or filtering architectures 716, 718, and 728 may provide faster and more efficient computation of effects such as interpolating between frames of a rendered image sequence in an environment such as a smartphone, and can provide for longer battery life due to reduction in power needed to impart a desired effect and/or compute a result.

In some examples, a device such as smartphone 724 may use a dedicated signal processing and/or filtering architecture 728 for some tasks, such as relatively simple image rendering or processing that does not require substantial computational resources or electrical power, and offloads other processing tasks to a signal processing and/or filtering architecture 716 or 718 of cloud server 702 for more complex tasks.

Signal processing and/or filtering architectures 716, 718, and 728 of FIG. 7 may, in some examples, be implemented in software, where various nodes, tensors, and other elements of processing stages (e.g., processing blocks in FIG. 1) may be stored in data structures in a memory such as 706 or storage 710. In other examples, signal processing and/or filtering architectures 716, 718, and 728 may be implemented in hardware, such as a neural network structure that is embodied within the transistors, resistors, and other elements of an integrated circuit. In an alternate example, signal processing and/or filtering architectures 716, 718 and 728 may be implemented in a combination of hardware and software, such as a neural processing unit (NPU) having software-configurable weights, network size and/or structure, and other such configuration parameters.

Trained neural network 234 (FIG. 2) and other neural networks as described herein in particular examples, may be formed in whole or in part by and/or expressed in transistors and/or lower metal interconnects (not shown) in processes (e.g., front end-of-line and/or back-end-of-line processes) such as processes to form complementary metal oxide semiconductor (CMOS) circuitry. The various blocks, neural networks, and other elements disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

Computing devices such as cloud server 702, smartphone 724, and other such devices that may employ signal processing and/or filtering architectures can take many forms and can include many features or functions including those already described and those not described herein.

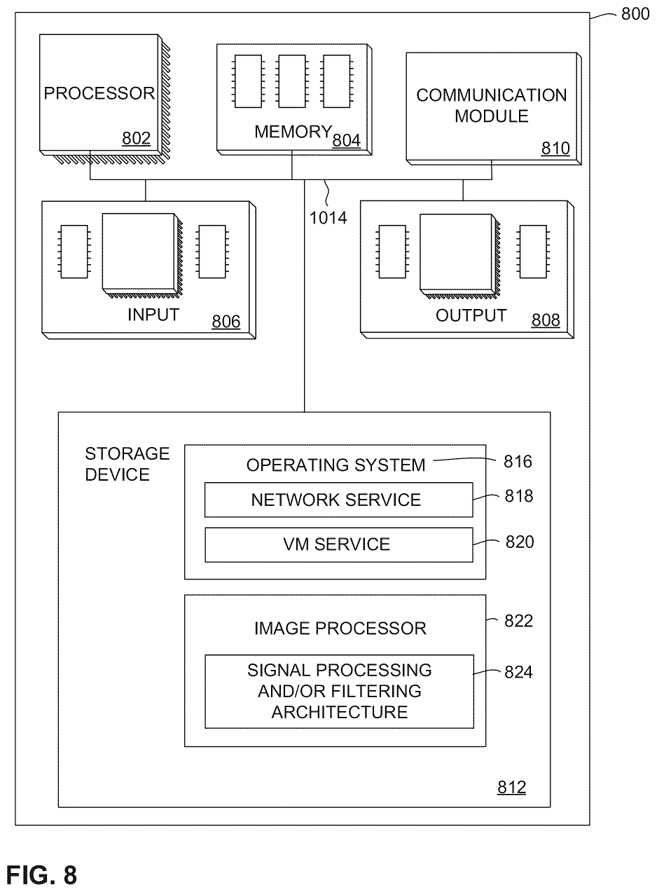

FIG. 8 shows a block diagram of a general-purpose computerized system, consistent with an example embodiment. FIG. 8 illustrates only one particular example of computing device 800, and other computing devices 800 may be used in other embodiments. Although computing device 800 is shown as a standalone computing device, computing device 800 may be any component or system that includes one or more processors or another suitable computing environment for executing software instructions in other examples, and need not include all of the elements shown here.

As shown in the specific example of FIG. 8, computing device 800 includes one or more processors 802, memory 804, one or more input devices 806, one or more output devices 808, one or more communication modules 810, and one or more storage devices 812.

Computing device 800, in one example, further includes an operating system 816 executable by computing device 800. The operating system includes in various examples services such as a network service 818 and a virtual machine service 820 such as a virtual server. One or more applications, such as image processor 822 are also stored on storage device 812, and are executable by computing device 800.

Each of components 802, 804, 806, 808, 810, and 812 may be interconnected (physically, communicatively, and/or operatively) for inter-component communications, such as via one or more communications channels 814. In some examples, communication channels 814 include a system bus, network connection, inter-processor communication network, or any other channel for communicating data. Applications such as image processor 822 and operating system 816 may also communicate information with one another as well as with other components in computing device 800.

Processors 802, in one example, are configured to implement functionality and/or process instructions for execution within computing device 800. For example, processors 802 may be capable of processing instructions stored in storage device 812 or memory 804. Examples of processors 1002 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 812 may be configured to store information within computing device 800 during operation. Storage device 812, in some examples, is known as a computer-readable storage medium. In some examples, storage device 812 comprises temporary memory, meaning that a primary purpose of storage device 812 is not long-term storage. Storage device 812 in some examples is a volatile memory, meaning that storage device 812 does not maintain stored contents when computing device 800 is turned off. In other examples, data is loaded from storage device 812 into memory 804 during operation. Examples of volatile memories include random access memories (RAM), dynamic random access memories (DRAM), static random access memories (SRAM), and other forms of volatile memories known in the art. In some examples, storage device 812 is used to store program instructions for execution by processors 802. Storage device 812 and memory 804, in various examples, are used by software or applications running on computing device 800 such as image processor 1022 to temporarily store information during program execution.

Storage device 812, in some examples, includes one or more computer-readable storage media that may be configured to store larger amounts of information than volatile memory. Storage device 812 may further be configured for long-term storage of information. In some examples, storage devices 812 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 800, in some examples, also includes one or more communication modules 810. Computing device 800 in one example uses communication module 810 to communicate with external devices via one or more networks, such as one or more wireless networks. Communication module 810 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 800 uses communication module 810 to wirelessly communicate with an external device such as via public network 722 of FIG. 7.

Computing device 800 also includes in one example one or more input devices 806. Input device 806, in some examples, is configured to receive input from a user through tactile, audio, or video input. Examples of input device 806 include a touchscreen display, a mouse, a keyboard, a voice responsive system, video camera, microphone or any other type of device for detecting input from a user.

One or more output devices 808 may also be included in computing device 800. Output device 808, in some examples, is configured to provide output to a user using tactile, audio, or video stimuli. Output device 808, in one example, includes a display, a sound card, a video graphics adapter card, or any other type of device for converting a signal into an appropriate form understandable to humans or machines. Additional examples of output device 808 include a speaker, a light-emitting diode (LED) display, a liquid crystal display (LCD or OLED), or any other type of device that can generate output to a user.

Computing device 800 may include operating system 816. Operating system 816, in some examples, controls the operation of components of computing device 800, and provides an interface from various applications such as image processor 822 to components of computing device 800. For example, operating system 816, in one example, facilitates the communication of various applications such as image processor 822 with processors 802, communication unit 810, storage device 812, input device 806, and output device 808. Applications such as image processor 822 may include program instructions and/or data that are executable by computing device 800. As one example, image processor 822 may implement a signal processing and/or filtering architecture 824 to perform image processing tasks or rendered image processing tasks such as those described above, which in a further example comprises using signal processing and/or filtering hardware elements such as those described in the above examples. These and other program instructions or modules may include instructions that cause computing device 800 to perform one or more of the other operations and actions described in the examples presented herein.

Features of example computing devices in FIGS. 7 and 8 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in the figures and text associated with the foregoing figures of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

What is claimed is:

1. A method, comprising:
generating motion vector frames, comprising generating a preceding warped motion vector frame from a preceding image frame using motion vectors, and generating a following warped motion vector frame from a following image frame using motion vectors;
generating optical flow frames, comprising generating a preceding warped optical flow frame from a preceding image frame using optical flow, and generating a following warped optical flow frame from a following image frame using optical flow;
predicting blending parameters associated with each of the motion vector frames and the optical flow frames for blending the motion vector frames and the optical flow frames to generate an interpolated output frame; and
for each pixel in the interpolated output frame, blending either the motion vector frames or the optical flow frames using the predicted blending parameters based on whether a highest blending parameter for the pixel is associated with a motion vector frame or an optical flow frame.

2. The method of claim 1, wherein blending either the motion vector frames or the optical flow frames comprises blending the preceding warped motion vector frame and the following warped motion vector frame using the predicted blending parameters if a highest blending parameter for the pixel is a preceding warped motion vector frame parameter or a following warped motion vector frame parameter, or blending the preceding warped optical flow frame and the following warped optical flow frame using the predicted blending parameters if a highest blending parameter for the pixel is a preceding warped optical flow frame parameter or a following warped optical flow frame parameter.

3. The method of claim 1, wherein predicting blending parameters associated with each of the motion vector frames and the optical flow frames comprises predicting the blending parameters using a trained neural network.

4. The method of claim 3, wherein the trained neural network is provided the generated motion vector frames and generated optical flow frames as input tensors to predict the blending parameters.

5. The method of claim 1, further comprising providing rendered object depth information for the preceding image frame, the following frame, or a combination thereof, a calculated disocclusion mask, or both, as input tensors to a neural network.

6. The method of claim 1, wherein at least one of generating motion vector frames and generating optical flow frames is performed using a scatter-gather operation.

7. The method of claim 1, wherein generating motion vector frames and optical flow frames occurs at a resolution reduced to a full resolution of the preceding image frame and the following image frame.

8. The method of claim 7, wherein blending either the motion vector frames or the optical flow frames using the predicted blending parameters based on whether a highest blending parameter for the pixel is associated with a motion vector frame or an optical flow frame comprises gathering and warping preceding and following RGB frames at a full resolution using either the motion vectors or the optical flow associated with the motion vector frames or the optical flow frames.

9. The method of claim 1, wherein the predicted blending parameters are further used to indicate by pixel a proportion of preceding and following motion vector frames or preceding and following optical flow frames to blend in generating the interpolated output frame.

10. A computing device, comprising:
a memory comprising one more storage devices; and
one or more processors coupled to the memory, the one or more processors operable to execute instructions stored in the memory to, for a rendered image sequence:
generate motion vector frames, comprising generating a preceding warped motion vector frame from a preceding image frame using motion vectors, and generating a following warped motion vector frame from a following image frame using motion vectors;
generate optical flow frames, comprising generating a preceding warped optical flow frame from a preceding image frame using optical flow, and generating a following warped optical flow frame from a following image frame using optical flow;
predict blending parameters associated with each of the motion vector frames and the optical flow frames for blending the motion vector frames and the optical flow frames to generate an interpolated output frame; and
for each pixel in the interpolated output frame, blend either the motion vector frames or the optical flow frames using the predicted blending parameters based on whether a highest blending parameter for the pixel is associated with a motion vector frame or an optical flow frame.

11. The computing device of claim 10, wherein blending either the motion vector frames or the optical flow frames comprises blending the preceding warped motion vector frame and the following warped motion vector frame using the predicted blending parameters if a highest blending parameter for the pixel is a preceding warped motion vector frame parameter or a following warped motion vector frame parameter, or blending the preceding warped optical flow frame and the following warped optical flow frame using the predicted blending parameters if a highest blending parameter for the pixel is a preceding warped optical flow frame parameter or a following warped optical flow frame parameter.

12. The computing device of claim 10, wherein predicting blending parameters associated with each of the motion vector frames and the optical flow frames comprises predicting the blending parameters using a trained neural network.

13. The computing device of claim 12, wherein the trained neural network is provided the generated motion vector frames and generated optical flow frames as input tensors to predict the blending parameters.

14. The computing device of claim 10, the one or more processors further operable to provide rendered object depth information for the preceding image frame, the following frame, or a combination thereof, a calculated disocclusion mask, or both, as input tensors to a neural network.

15. The computing device of claim 10, wherein at least one of generating motion vector frames and generating optical flow frames is performed using a scatter-gather operation.

16. The computing device of claim 10, wherein generating motion vector frames and optical flow frames occurs at a resolution reduced to a full resolution of the preceding image frame and the following image frame.

17. The computing device of claim 16, wherein blending either the motion vector frames or the optical flow frames using the predicted blending parameters based on whether a highest blending parameter for the pixel is associated with a motion vector frame or an optical flow frame comprises gathering and warping preceding and following RGB frames at a full resolution using either the motion vector frames or an optical flow associated with the motion vector frames or the optical flow frames.

18. The computing device of claim 10, wherein the predicted blending parameters are further used to indicate by pixel a proportion of preceding and following motion vector frames or preceding and following optical flow frames to blend in generating the interpolated output frame.

19. A method of training a neural network, comprising:
receiving an input tensor in an input layer of a neural network, the input tensor representing a preceding motion vector frame, a following motion vector frame, a preceding optical flow frame, and a following optical flow;
providing an output tensor to an output layer of the neural network, the output tensor representing:
one or more coefficients predicting blending parameters to be used in blending either the preceding motion vector frame and the following motion vector frame, or the preceding optical flow frame and the following optical flow frame based on whether a highest blending parameter for a pixel location is associated with a motion vector frame or an optical flow frame; and
training the neural network to predict the provided output tensor based on the received input tensor by using backpropagation to adjust a weight of one or more activation functions linking one or more nodes of one or more layers of the neural network.

20. The method of claim 19, wherein the input tensor representing a preceding motion vector frame, a following motion vector frame, a preceding optical flow frame, and a following optical flow are at reduced resolution compared to a rendered preceding image frame and a rendered following image frame.
